(19) United States
(12) Patent Application Publication
(10) Pub. No.: US 2009/0019649 A1
(43) Pub. Date: Jan. 22, 2009

(54) Electric toothbrush

(75) Inventor: Robert G. Dickie, King City (CA)

Correspondence Address: SAND & SEBOLT, AEGIS TOWER, SUITE 1100, 4940 MUNSON STREET, NW, CANTON, OH, 44718-3615, US

(73) Assignee: BRUSHPOINT INNOVATIONS INC., King City (CA)

(21) Appl. No.: 11/879,561

(22) Filed: Jul. 18, 2007

(51) Int. Cl. A61C 17/22

(52) U.S. Cl. 15/22.1

(57) ABSTRACT

The device of the present invention is a split head toothbrush having a powered mechanism that actively causes the two portions of the split head to move relative to each other. The toothbrush includes a camshaft that is operationally connected to a motor in the handle of the brush. The camshaft extends through the neck of the brush and into the head, terminating in the head at a point beneath the bristles. The camshaft has two offset cam lobes that contact both of the portions of the split head. As the camshaft rotates, the cam lobes cause the portions of the split head to move upwardly and downwardly relative to each other. The head of the toothbrush may be permanently attached to the handle or may be selectively detached therefrom.

### BACKGROUND OF THE INVENTION

1. Technical Field

This invention generally relates to dental hygiene. More particularly, the invention relates to a cleaning implement for teeth. Specifically, the invention relates to an electric toothbrush in which a camshaft that is operationally connected to a motor in the brush handle, extends from the handle and into the head and directly transmits motion to the head and bristles extending outwardly therefrom.

2. Background Information

The goal of every electric powered toothbrush designer is to make a fully active powered-head toothbrush the same size and look and feel as a small manual toothbrush. Some toothbrushes have been designed and manufactured to achieve this end, such as the Pulsar™ made by Procter & Gamble. These toothbrushes have a split head onto with a plurality of movable bristles mounted thereon. When pressure is applied to the bristles during brushing, the split portions of the head are able to be deflected independently of each other. Furthermore, these toothbrushes have a tiny, vibratory motor installed in the handle, as close to the brush head as space and styling will allow. A camshaft extends from the motor into the neck of the brush and a small, and D-shaped weight hangs off the end of the camshaft. The camshaft terminates a distance away from the head upon which the bristles are mounted. As the camshaft rotates, the weight produces a vibration that is transmitted through the neck and into head and bristles. This vibration causes the bristles to move back and forth and gives the toothbrush the appearance of having a very active head. Most of the vibration is felt in the user's hand and the vibration is not transmitted as much to the brush head itself. As soon as any pressure is applied to the ends of the bristles, such as during brushing, the vibration caused by the weight is dampened and substantially ceases.

U.S. Publication No. 2006/0272112 in the name of Braun et al and assigned to The Gillette Company, discloses a toothbrush that operates in the manner described above. The toothbrush disclosed in this publication has a split head with two portions that can move independently. The toothbrush also includes a powered mechanism for setting up a vibration in the head of the brush. The handle of the brush includes a battery and a motor and a drive shaft projects outwardly from the motor and rotates to drive an eccentrically mounted weight at the end thereof. The rotating weight sets up a vibration that is transmitted to all parts of the brush. While the head of this brush is split into two portions and the portions are able to move independently, the portions are only moved in this manner through direct pressure when the bristles contact the teeth. The vibrations produced by the weight may cause very small independent movements in the two portions, but any such movement is essentially dampened as soon as the bristles contact the teeth and pressure is applied thereto during brushing.

U.S. Pat. No. 6,564,416, issued to Claire et al and also assigned to Gillette Canada Company, discloses a manual toothbrush that has a head which is split longitudinally into two portions. The portions are angled transversely to one another and define an opening between them. The opening permits water to flow through the head to facilitate flushing away of particulate materials that have been removed from the teeth by the bristles. The two portions may be movable independently of each other, but this movement is passive in that it is only caused by pressure applied on the regions during brushing U.S. Publication No. 2004/0177462 in the name of Brown, Jr. et al, which again is assigned to The Gillette Company, discloses a manual toothbrush that has a head which is split into two portions. The split in the head permits the two portions to flex or move independently of each other but, once again that movement is passive in that it is only caused by pressure applied to the bristles by the teeth during brushing. An opening is defined between the two movable portions and the opening permits water and debris removed from the teeth to flow therethrough.

U.S. Pat. No. 5,987,681 issued to Hahn et al discloses an electric toothbrush that includes a mechanism for vibrating the head and therefore the tooth cleaning elements or bristles mounted thereon. The toothbrush includes a handle which houses a rotary motor. An unbalanced weight is provided on one or both sides of a shank close to the head of the brush. A drive shaft extends outwardly from the motor and drives the shank. When the motor is activated then the head of the toothbrush is vibrated.

There is therefore a need in the art for a toothbrush that includes a mechanism for actively moving the two portions of a split head type toothbrush to improve the cleaning power of the brush.

### SUMMARY OF THE INVENTION

The device of the present invention is a split head toothbrush having a powered mechanism that actively causes the two portions of the split head to move relative to each other. The toothbrush includes a camshaft that is operationally connected to a motor in the handle of the brush. The camshaft extends through the neck of the brush and into the head, terminating in the head at a point beneath the bristles. The camshaft has two offset cam lobes that contact both of the portions of the split head. As the camshaft rotates, the cam lobes cause the portions of the split head to move upwardly and downwardly relative to each other. The head of the toothbrush may be permanently attached to the handle or may be selectively detached therefrom.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is side view of the electric toothbrush in accordance with the present invention;

FIG. 2 is an enlarged cross-sectional side view of the toothbrush

FIG. 3 is an enlarged cross-sectional side view of the toothbrush shown from the end of the first camshaft section to the tip of the head;

FIG. 4 is a top view of the toothbrush head taken through line 44 of FIG. 3;

FIG. 5 is an exploded left perspective view of the first and second head sections shown with the bristles removed therefrom for clarity;

FIG. 5a is an exploded right perspective view of first and second head sections with the bristles removed;

FIG. 5b is a rear view of the first and second head sections attached to each other and showing the camshaft extending through the neck portion and into the body portion of the head;

FIG. 6 is a front view of the motor and the camshaft removed from the toothbrush;

FIG. 7 is a cross-sectional side view of a portion of the toothbrush with the bristles removed and showing the camshaft in position to flex the first and second sections away from each other;

FIG. 8 is a side view of the portion of the toothbrush shown in FIG. 7 and showing the second head section being moved toward the right by the camshaft and the first head section being moved toward the left;

FIG. 9 is a bottom view of the first and second head sections in a flexed position and taken through line 9-9 of FIG. 8;

FIG. 10 is a cross-sectional side view of a portion of the toothbrush head where the camshaft is causing the second head section being moved toward the left and the first head section being moved to the right;

FIG. 11 is a side view of the portion of the toothbrush shown in FIG. 10 and showing the first head section being moved toward the right by the camshaft and the second head section being moved toward the left;

FIG. 12 is a bottom view of the first and second head sections in a flexed position and taken through line 12-12 of FIG. 11;

FIG. 13 is cross-sectional side view of a portion of the toothbrush and showing the connection between the camshaft and the drive shaft upon pressure being applied to the bristles and therefore the head in response to pressure being applied to the bristles during brushing;

FIG. 14 is a side view of the portion of the toothbrush shown in FIG. 13;

FIG. 15 is an exploded side view of a second embodiment of the toothbrush showing that the head thereof is detachably connectable to the handle; and

FIG. 16 is an exploded cross-sectional side view of the toothbrush of FIG. 15 shown from the motor to the tip of the head.

### DETAILED DESCRIPTION OF THE INVENTION

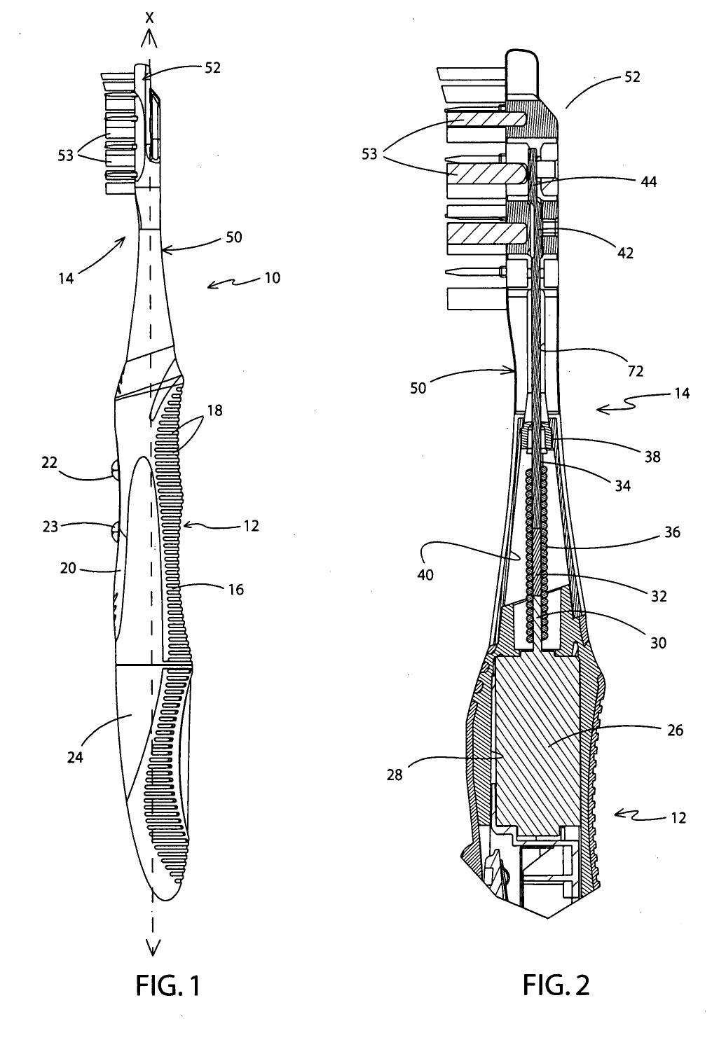

Referring to FIGS. 1-14 there is shown a first embodiment of an electric toothbrush in accordance with the present invention and generally indicated at 10. Toothbrush 10 includes a handle 12 and a head 14 and has a longitudinal axis “X” (FIG. 1). In the first embodiment, handle 12 and head 14 are integrally formed with each other. Handle 12 is ergonomically designed so that it is easily gripped in that a first surface 16 thereof is contoured and textured with ribs 18. A second surface 20 of handle 12 houses the control button 22 for activating brush 10 and control button 23 for deactivating brush 10. The bottom end 24 of handle 12 may be unscrewed or otherwise detached to allow access to a battery compartment within handle 12.

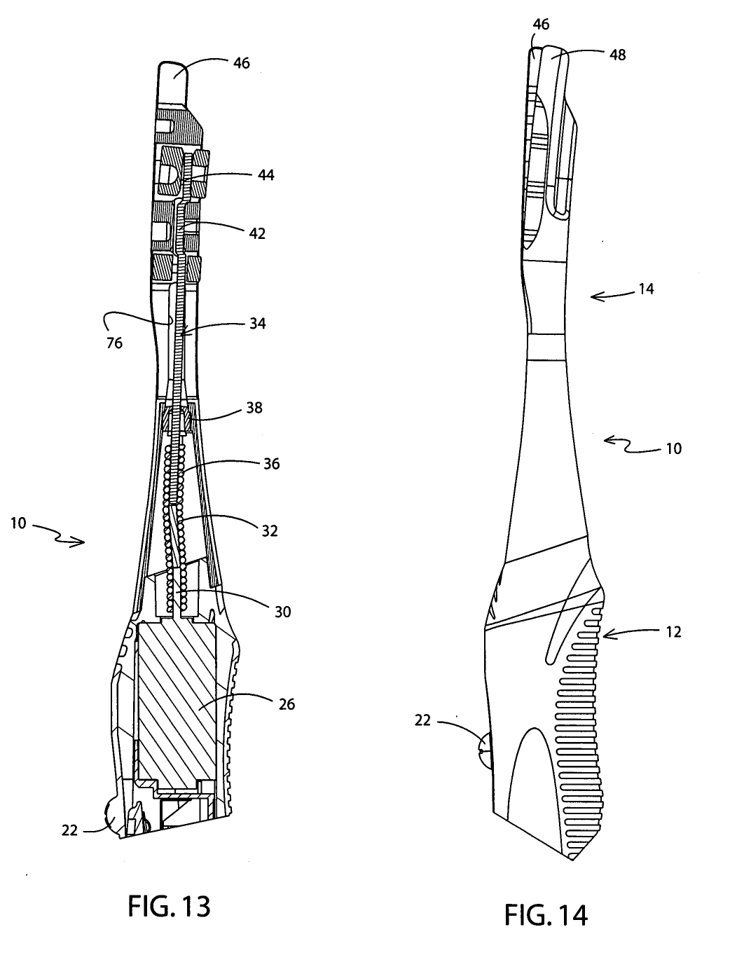

Referring to FIG. 2, a motor 26 is housed within an interior cavity 28 of handle 12. Motor 26 is driven by one or more batteries, but preferably by a single AAA battery. A drive shaft 30 extends outwardly from motor 26 and into a lower portion of the neck 50 of brush 10. One end of a camshaft abuts an end of drive shaft 30. The camshaft comprises a shorter first camshaft section 32 and a longer second camshaft section 34 which are in end to end contact with each other. First camshaft section 32 abuts the end of drive shaft 30. A second end of first camshaft section 32 abuts second camshaft section 34. A coiled flexible spring 36 tightly surrounds a portion of drive shaft 30, the entire length of first camshaft section 32 and a portion of second camshaft section 34. Spring 36 maintains a flexible contact between drive shaft 30, first camshaft section 32 and second camshaft section 34 and ensures that any motion of drive shaft 30 is imparted to second camshaft section 34. Spring 36 also ensures that if head 14 is bent backwardly during brushing, first camshaft section 32 does not become misaligned with motor 26. This flexible operational contact is illustrated in FIGS. 13 and 14.

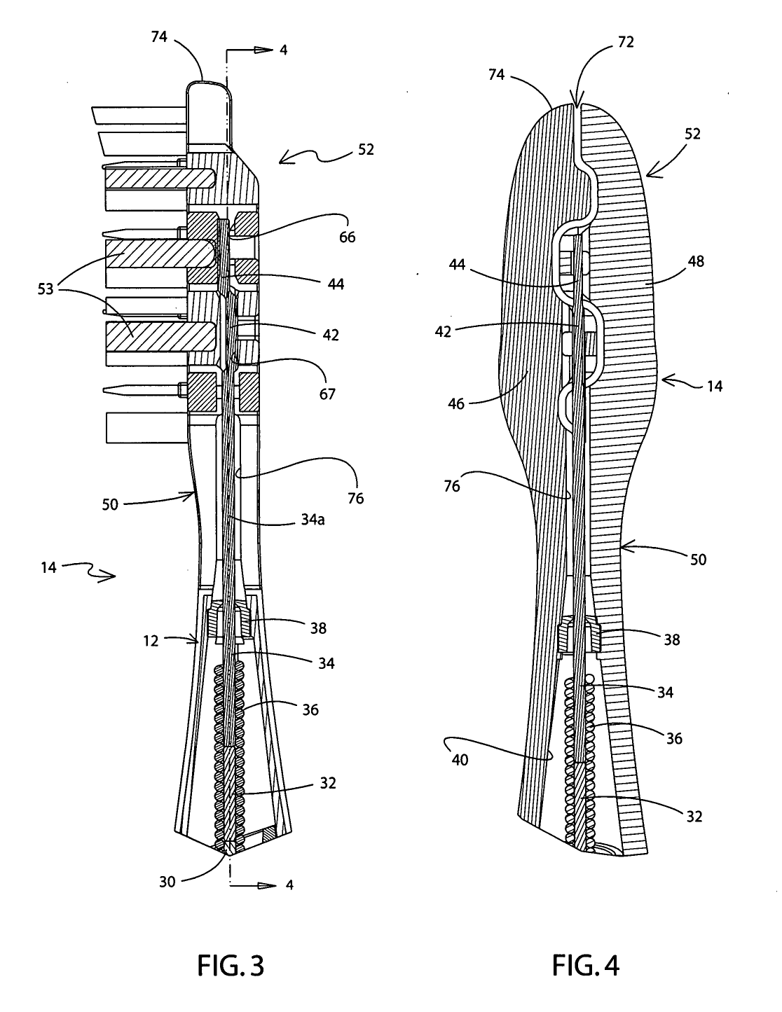

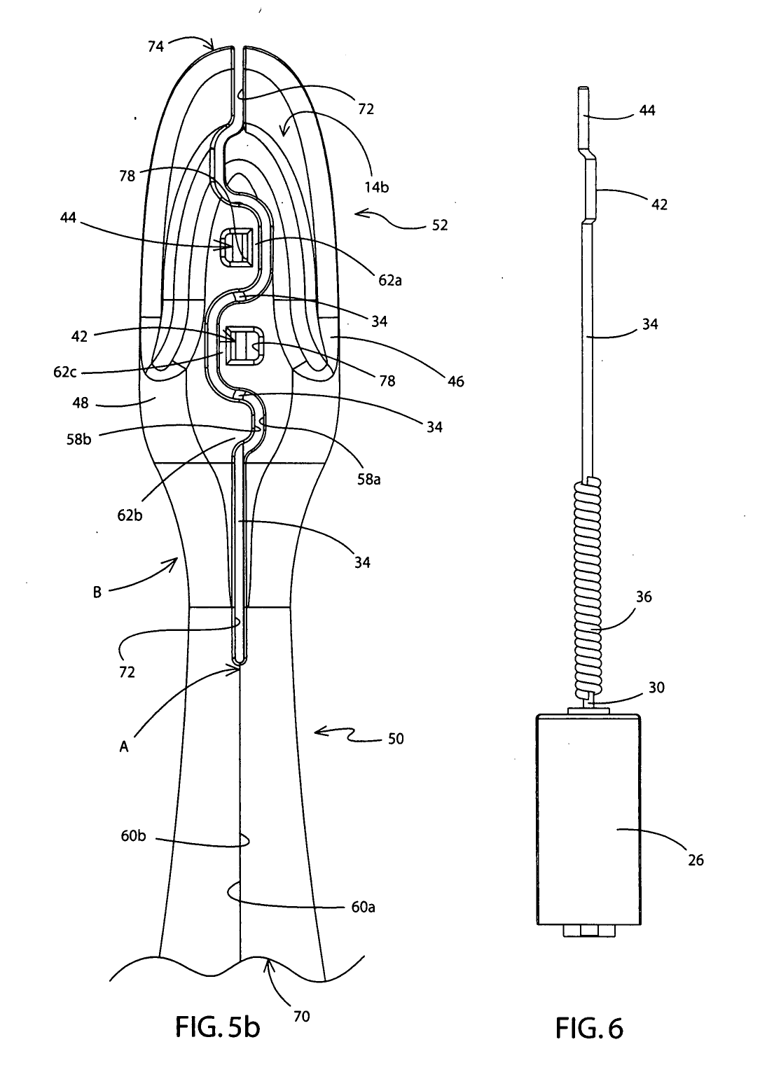

Second camshaft section 34 is a thin rod manufactured from stainless steel. Second camshaft section 34 passes through a soft rubber seal 38 and into head 14, terminating at a point underneath the region of the head where bristles 53 are mounted. Seal 38 is provided to prevent water and debris removed from the teeth during brush from entering cavity 40. Second camshaft section 34 terminates in a first and a second cam lobe 42, 44 (FIGS. 3 and 6). First and second cam lobes 42, 44 are offset relative to each other and to the main shaft 34a of second camshaft section 34.

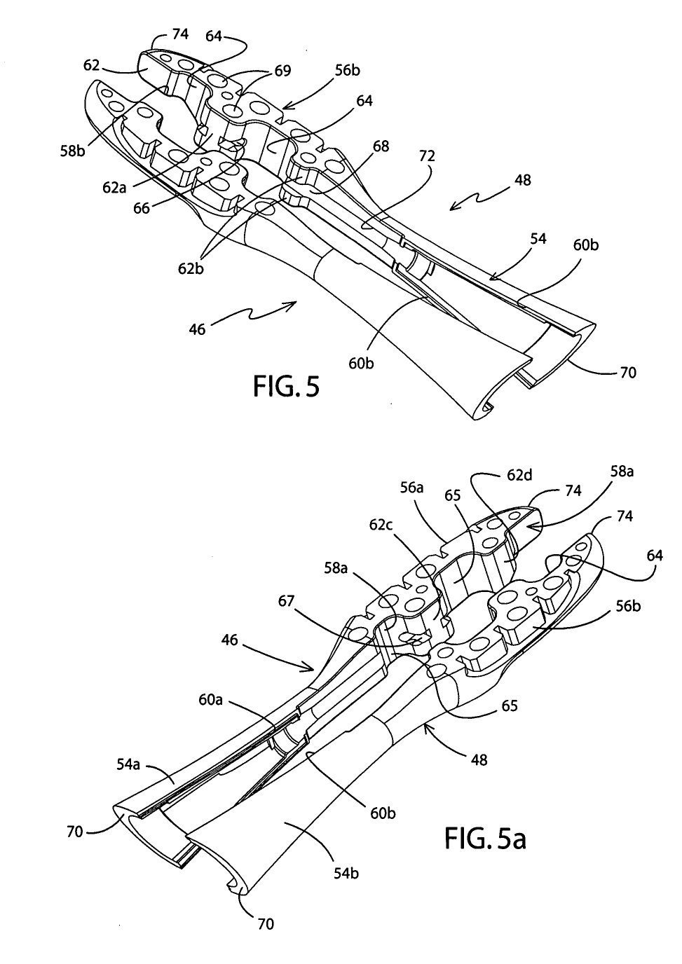

Referring to FIGS. 5-5b and in accordance with a specific feature of the present invention, head 14 of toothbrush 10 is manufactured from two separate molded head sections 46, 48. Each head section 46, 48 includes a neck portion 54 and a body portion 56. When head sections 46, 48 are joined together, the two neck portions 54a, 54b (FIG. 5a) form the elongated, thinner neck 50 of brush 10, and the two body portions 56a, 56b form the wider body 52. A plurality of bristles or bristle tufts 53 extend outwardly from one of the surfaces of body 52. Preferably, bristles or bristle tufts 53 are fixedly mounted to body 52 and only flex relative thereto as opposed to the bristles being pivotally or rotatably mounted within body 52.

Each body portion 56a, 56b of head sections 46, 48 is provided with an arcuately contoured inner wall 58a, 58b. Neck portions 54a, 54b are each provided with an angular or planar inner wall 60a, 60b. The contours of the inner wall 58a are complementary to the contours of inner wall 58b and are designed to substantially mesh with each other. Inner walls 60a, 60b are also complementary and designed to mate with each other when brush 10 is assembled during manufacture.

FIG. 5 shows head section 48 in greater detail. Inner wall 58b of head section 48 is shaped to form a plurality of arcuate protrusions 62 and recesses 64. A first protrusion 62a defines an aperture 66 therein that is aligned with longitudinal axis “X” of brush 10. Aperture 66 is four-sided in cross-sectional shape, being substantially rectangular or square in cross-sectional shape. A second protrusion 62b of inner wall 58b defines an axially aligned slot 68 therethrough. Slot 68 is substantially U-shaped in cross-section. The shape of aperture 66 and slot 68 substantially resists the tendency of head portions 46, 48 to split apart in response to rotation of camshaft lobes 42, 44. Neck portion 54b of head section 48 is substantially C-shaped in cross-section and tapers in size from end 70 toward body portion 56b. An elongated narrow channel 72 is defined in that part of neck portion 54b proximate body portion 56b. Channel 72 is longitudinally aligned and substantially continuous with groove 68. Head section 48 includes a plurality of holes 69 in an upper surface thereof. These holes are provided for mounting bristles 53 therein.

FIG. 5a shows inner wall 58a of head section 46 in greater detail. Inner wall 58a is similarly configured to inner wall 58b in that it includes a plurality of arcuate protrusions 62c, 62d and recesses 65. Protrusions 62c, 62d on inner wall 58a are designed to mesh with the protrusions 62a, 62b on inner wall 58b. So, for example, protrusion 62c on inner wall 58a meshes with protrusions 62a and 62b on inner wall 58b. Furthermore, protrusion 62c defines an aperture 67 therein that is alignable with aperture 66 in protrusion 62a and with groove 68 in protrusion 62b. Aperture 67 is four sided in cross-sectional shape. Furthermore second protrusion 62b has planar interior walls that define groove 68. When apertures 66, 67, groove 68 and channel 72 are aligned, an elongated bore 76 is formed which extends through head 14 and terminates only a short distance away from tip 74 of brush 10. Second camshaft section 34 is received through this bore 76. When second camshaft section 34 is engaged in bore 76, and specifically when the first and second lobes 42, 44 are retained in the four-sided apertures 66, 67 respectively, first and second head sections 46, 48 are substantially prevented from separating laterally from each other.

FIG. 5b shows that when head sections 46, 48 are secured together by gluing or heat welding, the inner walls 60a, 60b of the two neck portions 54a, 54b are attached together from ends 70 to a point “A”. Point “A” is disposed a spaced distance away from a point “B” where body 52 of head 14 originates. The remaining length of inner walls 60a, 60b and all of inner walls 58a, 58b from point “B” to tip 74 are not secured together in any way. A narrow slit 72 is formed between inner walls 58a, 58b and extends for a distance between inner walls 60a, 60b. Slit 72 originates at point “A” and terminates at tip 74 of head 14. Slit 72 permits water and debris removed from the teeth to be flushed away from bristles 53. The presence of slit 72 also enables the body portions and the unattached parts of the neck of head sections 46, 48 to flex relatively easily upwardly and downwardly out of alignment with each other as shown in FIG. 8.

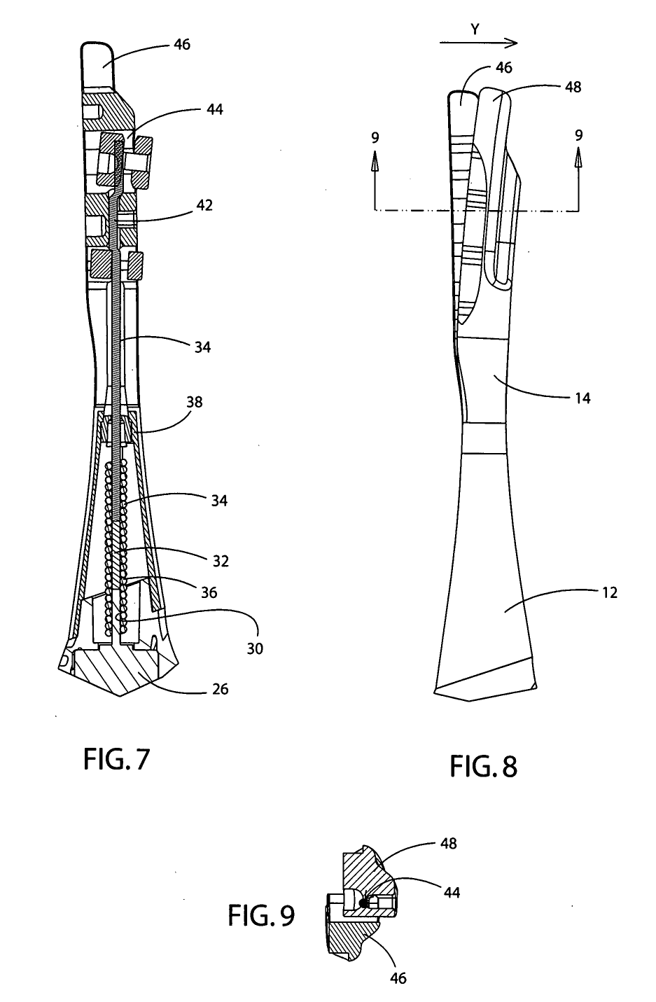

This possible relative movement between head sections 46, 48 is not, however only a passive movement caused by the bristles 53 engaging the teeth during brushing. The transverse movement of head sections 46, 48 relative to each other and to the longitudinal axis “X” of brush 10 is also a movement powered by the camming action of second camshaft section 34. Second camshaft section 34 extends through bore 76 and engages both of head sections 46, 48. The shaft 34a of second camshaft section 34 extends through channel 72 of head sections 46, 48. The first cam lobe 42 of second camshaft section 34 extends through the aperture or groove 67 (FIG. 3) in protrusion 62c of head section 46. The second cam lobe 44 is seated in aperture 66 in first protrusion 62a of head section 48. FIG. 5b shows that parts of second camshaft section 34 are visible through slit 72 and holes 78 in back surface 14b of head 14. Rotational movement generated by motor 26 causes second camshaft section 34 to rotate in bore 76. Because second camshaft section 34 extends into body portion 52 of head 14 and terminates in a region beneath bristles 53, the rotational motion of second camshaft section 34 is transmitted directly to first and second head sections 46, 48 through the action of cam lobes 42, 44. The motion of head sections 46, 48 relative to each other in response to the action of cam lobes 42, 44 is shown in FIGS. 7-12.

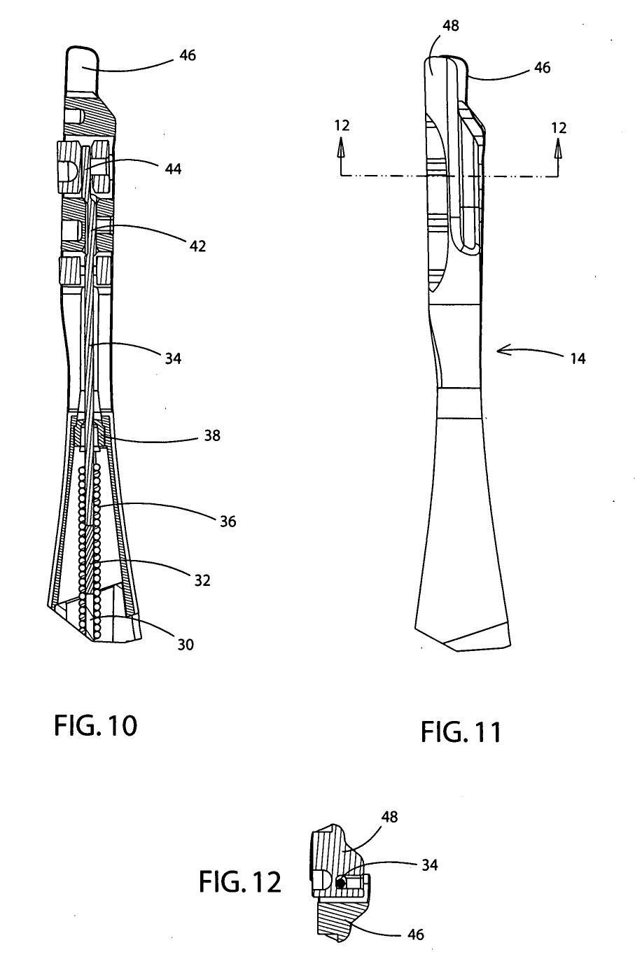

FIGS. 7-9 show second camshaft section 34 in a first position with cam lobe 44 forcing head section 48 to move out of alignment with head section 46 in the direction of arrow “Y”. The relative displacement is shown in FIG. 9. FIGS. 10-12 show second camshaft section 34 rotated through 180°. In this position, cam lobe 44 is oriented in such a manner that head section 48 has moved back into a rest position and is substantially aligned with head section 46 once again. As second camshaft section 34 continues to rotate through another 180°, cam lobe 44 moves once again into the position shown in FIG. 7 and head section 48 moves again in the direction of arrow “Y” and into the position shown in FIG. 8. Thus, head section 48 is caused to move alternatively into and out of alignment with head section 46 and longitudinal axis “X” of brush 10. These movements are very small and very rapid.

The entire head 14 of brush 10 is also able to flex somewhat in response to pressure applied on head 14 during brushing. As shown in FIGS. 13 & 14 this flexing motion may cause second camshaft section 34 to become misaligned with first cam section 32 and drive shaft 30. However, the flexible spring 36 maintains contact between second camshaft section 34, first cam section 32 and drive shaft 30, so that even in this flexed head position, head sections 46, 48 continue to be able to move independently of each other in response to rotation of second camshaft section 34.

Because bristles 53 are mounted onto head sections 46, 48, the movement of head sections 46, 48 in response to rotation of the second camshaft section 34 causes a corresponding motion in bristles 53. These movements in the transverse directions are very rapid and small in amplitude. This reduces the drag on bristles 53 as they engage the teeth and also reduces the amount of power the brush 10 uses. Consequently, toothbrush head continues to move when bristles contact the teeth, unlike the toothbrushes known in the prior art. Toothbrush 10 therefore has an active head 14 that is more efficient at removing particulate matter from the teeth.

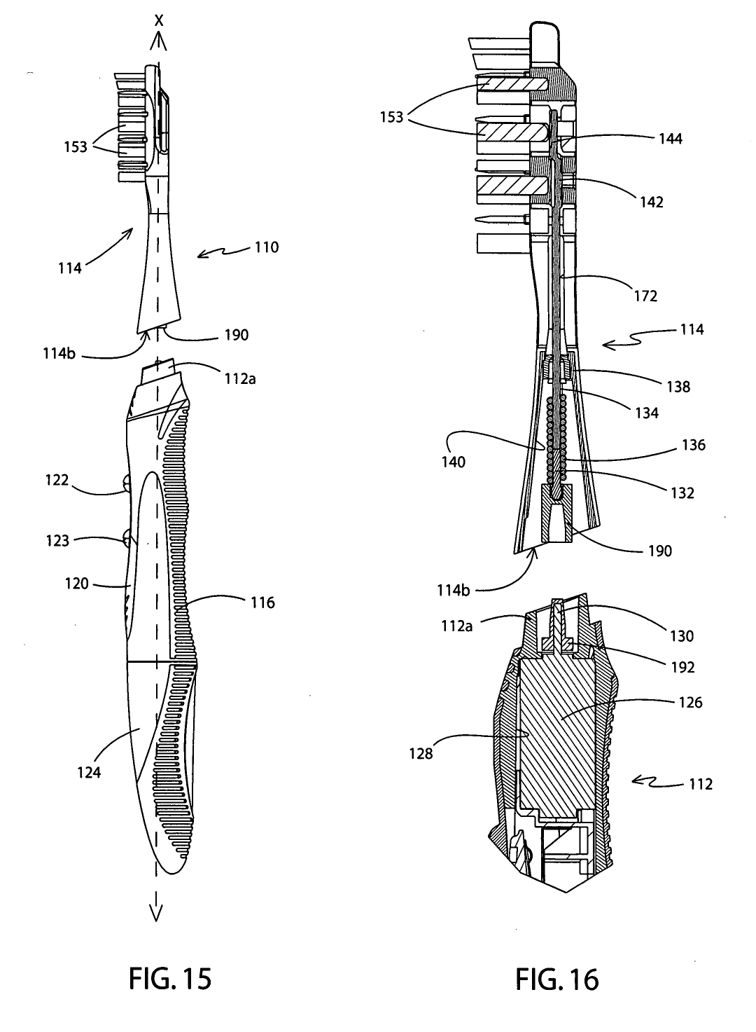

FIGS. 15 and 16 show a second embodiment of a toothbrush in accordance with the present invention and generally indicated at 110. In this second embodiment, the head 114 of brush 110 is removable from the handle 112. The detachable head 114 may be removed from handle 112 if bristles 153 become damaged through use, for example. A replacement head (not shown) may then be snap-fitted or otherwise secured to handle 112. As with the previous embodiment, handle 112 is contoured and includes ribs for gripping and control buttons 122, 123 on front surface 120. The other various components and operation of toothbrush 110 are substantially identical to those of toothbrush 10 except that flexible spring 136 surrounds the first camshaft section 132 and a portion of longer camshaft 134. First camshaft section 132 is secured to in a female connector 190 that projects slightly from the bottom end 114b of head 114. Drive shaft 130 is secured to a male connector 192 that is complementary to female connector 190. Male and female mating connectors 190, 192 are designed to mechanically and electrically connect drive shaft 130 to camshaft 134. It will be understood that female connector 190 may be secured to drive shaft 130 and male connector 192 may be secured to shorter camshaft section 132 without departing from the spirit of the present invention. Additionally, the male upper end 112a of handle 112 is complementary shaped to interlock with the female bottom end 114b of head 114. Head 114 is snap-fitted onto handle 112 and the two parts may be secured together by any other suitable means that will prevent the head 114 from separating accidentally from the handle 112 during brushing. It will be understood that the interlocking male and female ends of handle 112 and head 114 may alternatively be provided on the opposite components without departing from the spirit of the present invention.

It will be understood that while the camshaft is shown as comprising first camshaft section 32 and second camshaft section 34, a single continuous camshaft may be used in toothbrush 10.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. An electric toothbrush comprising:
a handle;
a head extending from the handle; wherein said head includes a first and a second head section that are disposed laterally adjacent and separate from each other;
a plurality of bristles extending outwardly from a surface of at least one of the head sections;
a powered camshaft extending from the handle and into the head; said camshaft contacting both of the first and second head sections and being adapted to cause the first and second head sections to move relative to each other when the camshaft is activated.

2. The electric toothbrush as defined in claim 1, wherein the camshaft includes a first and a second cam lobe, and the first cam lobe engages the first head section and the second cam lobe engages the second head section.

3. The electric toothbrush as defined in claim 2, wherein the first cam lobe and the second cam lobe are offset relative to each other.

4. The electric toothbrush as defined in claim 3, wherein each of the first and second head sections includes an inner wall; and wherein each inner wall comprises a plurality of alternating protrusions and recesses; and wherein the inner wall of the first head section is complementary to the inner wall of the second head section.

5. The electric toothbrush as defined in claim 4, wherein the first head section defines a first aperture therein; and the second head section defines a second aperture therein; and wherein a portion of the camshaft extends through the first and second apertures.

6. The electric toothbrush as defined in claim 5, wherein the first cam lobe extends through the first aperture and the second cam lobe extends through the second aperture.

7. The electric toothbrush as defined in claim 6, wherein at least one of the first and second apertures are four-sided in cross-sectional shape.

8. The electric toothbrush as defined in claim 7, further comprising a gap defined between the inner wall of the first section and the inner wall of the second section.

9. The electric toothbrush as defined in claim 8, wherein a third protrusion on the first head section defines a longitudinally aligned groove therein; and wherein said first and second apertures and the groove define a central bore through which the camshaft extends.

10. The electric toothbrush as defined in claim 1, further comprising a flexible connector that is engaged around the camshaft and is adapted to be engaged around a drive shaft extending from a motor; whereby said flexible connector is adapted to retain the camshaft in end to end contact with the drive shaft.

11. The electric toothbrush as defined in claim 10, wherein the camshaft comprises a longer cam section and a shorter cam section that are separate from each other, and wherein the flexible connector is engaged around at least a portion of the shorter cam section and a portion of the longer cam section and maintains end to end contact between the shorter and longer cam sections.

12. The electric toothbrush as defined in claim 11, wherein the flexible connector is a coil spring.

13. The electric toothbrush as defined in claim 12, wherein the spring defines a bore and the shorter cam section is at least partially positioned within the bore thereof.

14. The electric toothbrush as defined in claim 13, further comprising a motor having a drive shaft; at least a portion of the drive shaft extending into the bore of the coil spring and contacting an end of the shorter cam section; whereby upon activation of the motor, the motion of said drive shaft causes the shorter cam section to rotate.

15. The electric toothbrush as defined in claim 14, further comprising at least one AM battery retained within the handle of the toothbrush in operational contact with the motor.

16. The electric toothbrush as defined in claim 1, wherein the head is detachably connectable to the handle.

17. The electric toothbrush as defined in claim 16, wherein the camshaft comprises:
a longer camshaft section; wherein a first end of the longer camshaft section contacts both of the first and second head sections;
a shorter camshaft section having a first end thereof in end-to-end relation with a second end of the longer camshaft section;
a flexible connector that encircles the shorter camshaft section and at least a portion of the longer camshaft section; and
a first mating connector secured to a second end of the shorter camshaft section.

18. The electric toothbrush as defined in claim 17, wherein the handle includes:
a motor;
a drive shaft extending outwardly from the motor; and
a second mating connector secured to a free end of the drive shaft; and wherein said first and second mating connectors are complementary and are configured to snap fit together to connect the drive shaft to the camshaft.

19. The electric toothbrush as defined in claim 18, wherein one of the head and handle includes a female end and the other of the head and handle includes a male end; and wherein said female and male ends are complementary shaped to interlock when the head and handle are secured together.

20. A head for an electric toothbrush; said head comprising:
a neck having a first end adapted to detachably engage a handle of the electric toothbrush;
a body extending outwardly from a second end of the neck; said body comprising:
a first head section; and
a second head section disposed laterally adjacent to and separate from the first head section;
a plurality of bristles extending outwardly from an outer surface of each of the first and second head sections; and
a camshaft extending through a portion of each of the first and second head sections; said camshaft being adapted to be operationally connected to a powered motor in the handle when the head is attached to the handle; and wherein rotation of the camshaft by the motor causes the first head section to move relative to the second head section.

21. The toothbrush head as defined in claim 20, wherein the head has a longitudinal axis extending from a tip to the first end of the neck; and wherein said camshaft is disposed substantially aligned with the longitudinal axis of the head.

22. The toothbrush head as defined in claim 21, wherein the camshaft includes:
a shaft that is substantially aligned with the longitudinal axis of the head;
a first cam lobe that is offset relative to the shaft and engages the first head section; and
a second cam lobe that is offset relative to the first cam lobe and engages the second head section.

23. The toothbrush head as defined in claim 22, wherein the first cam lobe causes the first head section to move back and forth relative to the second head section when the camshaft is rotated, and causes the first head section to move back and forth into and out of alignment with the longitudinal axis of the head.

24. The toothbrush head as defined in claim 23, wherein the first head section includes a plurality of protrusions and recesses; and the second head section includes a plurality of protrusions and recesses; and at least one of the protrusions in the first inner wall defines a first aperture, and at least one of the protrusions in the second inner wall defines a second aperture; and the first aperture receives the first cam lobe of the camshaft therein; and the second aperture receives the second cam lobe of the camshaft therein.

25. The toothbrush head as defined in claim 24, wherein the first and second apertures are four-sided in cross-sectional shape.

26. The toothbrush head as defined in claim 20, further comprising a mating connector secured to an end of the camshaft; said mating connector being adapted to engage a complementary connector on the toothbrush handle.
